(19) United States
(12) Patent Application Publication
(10) Pub. No.: US 2025/0263049 A1
(43) Pub. Date: Aug. 21, 2025

(54) LIQUID STORAGE STRUCTURE FOR VEHICLE

(71) Applicant: TOYODA GOSEI CO., LTD., Kiyosu-shi (JP)

(72) Inventors: Takaki ITATSU, Aichi (JP); Koichi SUZUKI, Aichi (JP); Tomohiro KAJITANI, Aichi (JP); Masashi OTOYO, Aichi (JP); Hiroshi TAKAKURA, Aichi (JP)

(21) Appl. No.: 19/049,135

(22) Filed: Feb. 10, 2025

(30) Foreign Application Priority Data
Feb. 16, 2024 (JP) 2024-022093

(51) Int. Cl. B60S 1/50

(52) U.S. Cl. CPC B60S 1/50

(57) ABSTRACT

A liquid storage structure for a vehicle is applied to a vehicle in which a vehicle interior outer chamber is provided outside a vehicle interior, and a trunk and a liquid tank having a liquid storage chamber are disposed in the vehicle interior outer chamber. A framework portion of the liquid tank is configured by a tank body portion, the tank body portion having a wall portion forming an outer shell portion. The tank body portion has an opening in a part of the wall portion. In a state in which the opening is closed by a part of the trunk, the wall portion of the tank body portion is attached to the trunk at a peripheral edge portion of the opening in a close contact state. The liquid tank is constituted by the tank body portion and the part of the trunk that closes the opening.

### CROSS-REFERENCE TO RELATED APPLICATIONS

This application is based on and claims priority under 35 USC 119 from Japanese Patent Application No. 2024-022093 filed on Feb. 16, 2024, the entire content of which is incorporated herein by reference.

### TECHNICAL FIELD The present disclosure relates to a liquid storage structure for a vehicle.

### BACKGROUND ART

A front end panel (which may be called a front face support or a radiator support) is attached to a front end portion of a vehicle to maintain the rigidity of a vehicle body. A radiator, headlights, and the like are fixed to the front end panel which is a structural member (framework member).

In the vehicle, a washer tank that stores a washer fluid is mounted in a vehicle interior outer chamber provided outside a vehicle interior, for example, a power source room that accommodates a power source such as an engine or a motor.

With regard to such a front end panel and a washer tank, JP2003-72591A describes a liquid storage structure configured by attaching a washer tank made of resin to a front end panel.

### SUMMARY OF INVENTION

When a washer tank is attached to a front end panel which is a main structural member (framework member) of a vehicle, the following concern arises. The washer tank and washer fluid increase the total weight of the front end panel, reducing the natural frequency. This may lead to a decrease in ride comfort due to the rigidity of a vehicle body, which may affect the steering stability of the vehicle.

As the washer fluid is consumed or replenished, the total weight of the front end panel including the washer fluid greatly fluctuates. Accordingly, the natural frequency of the front end panel fluctuates, and the ride comfort due to the rigidity varies over time. This may also be a factor that affects the steering stability of the vehicle. Such problems may commonly occur in any liquid storage structure in which a liquid tank that stores a liquid other than the washer fluid is attached to the front end panel.

JP2021-146741A describes disposing a storage structure in the vehicle interior outer chamber. Based on this, it is conceivable that a liquid storage structure could be constructed by attaching a liquid tank such as the washer tank to a member disposed in the vehicle interior outer chamber. Although the liquid tank is attached to the front end panel in this configuration, such a liquid storage structure occupies a large space in the vehicle interior outer chamber, and there is room for improvement in terms of space efficiency.

According to an aspect of the present disclosure, there is provided a liquid storage structure for a vehicle having a following configuration.
(1) A liquid storage structure for a vehicle, the liquid storage structure being applied to a vehicle in which a vehicle interior outer chamber is provided outside a vehicle interior, and a trunk and a liquid tank having a liquid storage chamber are disposed in the vehicle interior outer chamber, in which
   a framework portion of the liquid tank is configured by a tank body portion, the tank body portion having a wall portion forming an outer shell portion,
   the tank body portion has an opening in a part of the wall portion,
   in a state in which the opening is closed by a part of the trunk, the wall portion of the tank body portion is attached to the trunk at a peripheral edge portion of the opening in a close contact state, and
   the liquid tank is constituted by the tank body portion and the part of the trunk that closes the opening.

According to the above configuration, unlike the front end panel, the trunk disposed in the vehicle interior outer chamber does not serve as a main structural member (framework member) of the vehicle. The trunk has a smaller effect on the ride comfort due to the rigidity of the vehicle body than the main structural member of the vehicle. Therefore, even if the natural frequency of the entire trunk and liquid tank is reduced due to the addition of the tank body portion and the liquid, the ride comfort due to the rigidity is unlikely to be reduced due to the addition of the tank body portion and the liquid. Here, the total weight of the liquid tank is defined as the sum of the weight of the liquid tank and the weight of the liquid in the storage chamber. Therefore, even if the total weight of the liquid tank fluctuates due to consumption or replenishment of the liquid, the consumption or replenishment of the liquid has a small effect on the ride comfort due to the rigidity.

According to the above configuration, the portion of the trunk that closes the opening also serves as a part of the wall portion of the liquid tank. In other words, a part of the trunk and a part of the wall portion of the liquid tank are shared. Therefore, as compared with a case where the trunk and the wall portion of the liquid tank do not have a common portion, the tank body portion is disposed at a location closer to the trunk. The liquid storage structure in which the tank body portion is attached to the trunk occupies less space in the vehicle interior outer chamber as compared with the case where the trunk and the wall portion of the liquid tank do not have a common portion.

(2) The liquid storage structure for a vehicle according to (1), in which a liquid stored in the storage chamber is a washer fluid, and the trunk and the tank body portion are each made of a resin material.

According to the above configuration, when the washer fluid freezes, the volume of the washer fluid increases. At this time, stress generated due to the expansion acts on the tank body portion and the trunk. However, the tank body portion and the trunk are both made of a resin material.

Therefore, the extension (deformation) of the tank body portion and the trunk absorbs a part of the stress.

(3) The liquid storage structure for a vehicle according to (1) or (2), in which the trunk and the tank body portion are made of a resin material or a composite material obtained by reinforcing a resin material with a reinforcing material, and the wall portion of the tank body portion is joined to the trunk at the peripheral edge portion of the opening by welding.

According to the above configuration, the wall portion of the tank body portion is joined to the trunk at the peripheral edge portion of the opening by welding. That is, an interface between the wall portion of the tank body portion and the trunk is melted by heat, and thus the wall portion is joined to the trunk. The portion where the wall portion of the tank body portion and the trunk are joined together is sealed without any gaps. Therefore, leakage of the liquid stored in the storage chamber from the joint portion is appropriately restricted.

According to the present invention, it is possible to improve space efficiency of a vehicle interior outer chamber while reducing the effect on steering stability of a vehicle.

### BRIEF DESCRIPTION OF DRAWINGS

Exemplary embodiment(s) of the present invention will be described in detail based on the following figures, wherein:

FIG. 1 is a perspective view of a liquid storage structure according to an embodiment, as viewed obliquely from the front;

FIG. 2 is a partial perspective view of a front portion of a vehicle to which the liquid storage structure of FIG. 1 is applied, illustrating a state in which a bonnet hood is slightly opened;

FIG. 3 is a partially exploded perspective view of FIG. 1;

FIG. 4 is a perspective view of the liquid storage structure according to the embodiment, as viewed obliquely from the rear;

FIG. 5 is a partially exploded perspective view of FIG. 4; and

FIG. 6 is a cross-sectional view taken along line 6-6 of FIG. 1.

### DESCRIPTION OF EMBODIMENTS

Hereinafter, an embodiment of a liquid storage structure for a vehicle will be described with reference to the drawings.

In the following description, a forward moving direction of a vehicle 10 is referred to as the front, and a backward moving direction is referred to as the rear. An upper-lower direction refers to an upper-lower direction of the vehicle 10, and a left-right direction refers to a vehicle width direction, which coincides with a left-right direction when the vehicle 10 moves forward.

As shown in FIG. 2, the vehicle 10 has a vehicle interior 15 as a space in which an occupant rides, and has a vehicle interior outer chamber outside the vehicle interior 15. The vehicle 10 of the present embodiment has a power source room 12 in which a power source (not shown) is accommodated as the vehicle interior outer chamber, and the power source room 12 is provided in front of the vehicle interior 15. The power source room 12 is called an engine room in an internal combustion engine vehicle in which an internal combustion engine is mounted as a power source, or in a hybrid vehicle in which an internal combustion engine and a motor are mounted as power sources. The power source room 12 is called a motor room in a fuel cell vehicle, an electric vehicle, or the like.

A front end panel (not shown, also called a radiator support) is attached to a front end portion of the power source room 12 for the purpose of maintaining the rigidity of a vehicle body 11. A radiator (not shown), headlights 16, and the like are fixed to the front end panel which is a structural member (framework member).

In the power source room 12, at least an engine, a motor, and the like as power sources are accommodated behind the front end panel. In addition to the power sources, a transmission, auxiliary equipment, a battery, and the like are appropriately accommodated in the power source room 12.

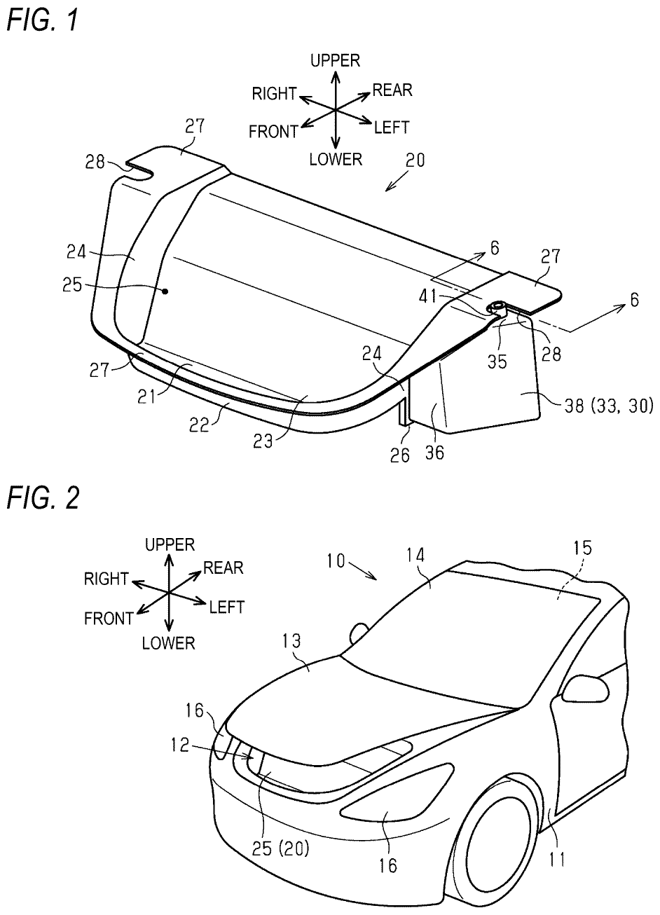

As shown in FIGS. 1 and 2, a trunk 20 is disposed in the power source room 12, and a washer tank 30 serving as a liquid tank is disposed in the power source room 12. Since the trunk 20 is located in a front portion of the vehicle body 11, the trunk 20 is also called a “frunk”.

### Trunk 20

As shown in FIGS. 1 and 4, the trunk 20 includes a bottom wall portion 21, a front wall portion 22, a rear wall portion 23, and a pair of side wall portions 24 as wall portions. The front wall portion 22 rises upward from a front edge portion of the bottom wall portion 21. The rear wall portion 23 is inclined with respect to the horizontal plane so as to be located upward toward a rear side from a rear edge portion of the bottom wall portion 21. The rear wall portion 23 is inclined to avoid interference with other components disposed in the power source room 12. The side wall portions 24 rise upward from both side edge portions of the bottom wall portion 21 in the left-right direction. A space surrounded by the bottom wall portion 21, the front wall portion 22, the rear wall portion 23, and the side wall portions 24 constitutes an accommodation portion 25 for accommodating luggage and the like. An upper end portion of the accommodation portion 25 is open. The open portion of the accommodation portion 25 is a portion that functions as an entrance and an exit for luggage and the like. When a bonnet hood 13 (see FIG. 2) of the vehicle 10 is closed, the open portion is closed by the bonnet hood 13.

A flat plate-shaped extension portion 26 extending downward from the rear wall portion 23 is formed at a rear portion of each of the side wall portions 24.

The trunk 20 has flange portions 27 around the accommodation portion 25. Here, the “side” and “direction” that intersect wall portions of the trunk 20, that is, the bottom wall portion 21, the front wall portion 22, the rear wall portion 23, and the pair of side wall portions 24, and that are away from a center portion (center of gravity) of the accommodation portion 25 are referred to as an “outside” and “outward”, respectively. The “side” and “direction” that intersect a wall portion of the trunk 20, such as the side wall portions 24, and that approach the center portion (center of gravity) of the accommodation portion 25 are referred to as “inside” and “inward”, respectively. A part of each of the flange portions 27 protrudes forward from an upper end portion of the front wall portion 22 outward in the front-rear direction. A part of the flange portion 27 protrudes outward in the left-right direction from an upper end portion of the side wall portion 24.

The flange portion 27 has a notch 28 formed at a location above each of the left and right extension portions 26. The notch 28 extends inward from an outer edge portion of the flange portion 27, that is, an edge portion on a side not connected to the side wall portion 24. Instead of the notch 28, a hole that vertically penetrates the flange portion 27 may be formed.

### Washer Tank 30

As shown in FIG. 6, the washer tank 30 has a storage chamber 32 for storing a washer fluid 31 as a liquid. The washer fluid 31 is a cleaning fluid that is to be sprayed toward a windshield 14 (see FIG. 2) of the vehicle 10.

The washer tank 30 is configured by a part of the trunk 20 (the rear portion of the side wall portion 24 and the extension portion 26) and a tank body portion 33 provided separately from the trunk 20.

The tank body portion 33 is a member that constitutes a framework portion of the washer tank 30. The tank body portion 33 is disposed on one side of the trunk 20 in the left-right direction, that is, outside the left side wall portion 24 in the present embodiment, and below the flange portion 27.

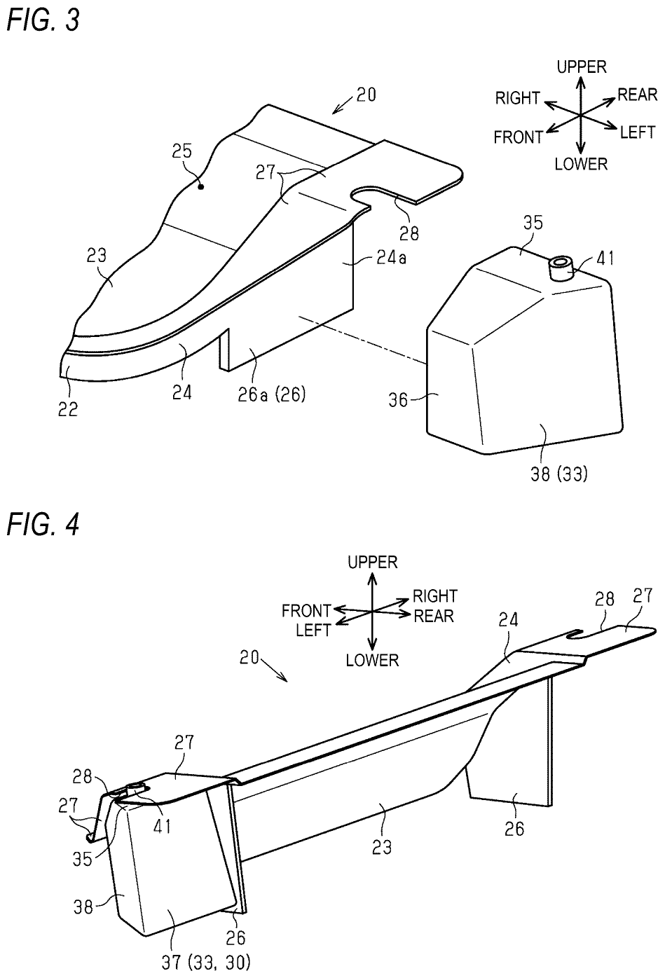

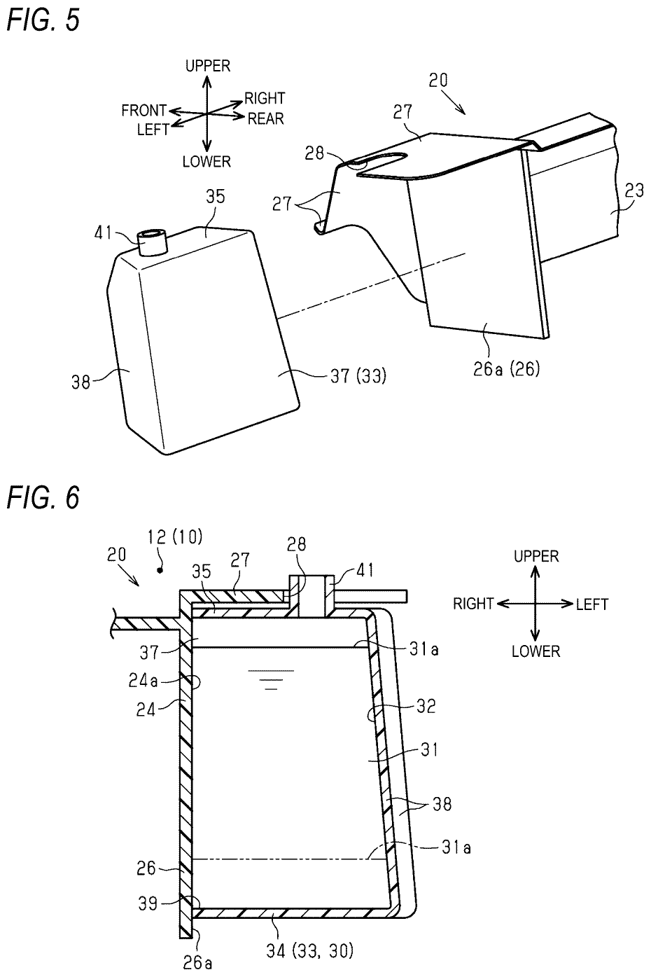

As shown in FIGS. 3, 5, and 6, an outer shell portion of the tank body portion 33 is configured by a wall portion. The tank body portion 33 has an opening 39 that connects the inside and the outside of the storage chamber 32 in the left-right direction in an inner portion which is a part of the wall portion. The wall portion includes a lower wall portion 34 and an upper wall portion 35 located above the lower wall portion 34. The wall portion further includes a front connecting wall portion 36, a rear connecting wall portion 37, and outer connecting wall portions 38 that extend in the upper-lower direction. The front connecting wall portion 36 connects a front edge portion of the lower wall portion 34 and a front edge portion of the upper wall portion 35. The rear connecting wall portion 37 connects a rear edge portion of the lower wall portion 34 and a rear edge portion of the upper wall portion 35. The outer connecting wall portions 38 connect outer edge portions of the lower wall portion 34 and outer edge portions of the upper wall portion 35.

The wall portion does not have a portion corresponding to an inner connecting wall portion. The opening 39 is defined by inner edge portions of the lower wall portion 34, the upper wall portion 35, the front connecting wall portion 36, and the rear connecting wall portion 37.

The opening 39 is closed by a part of the trunk 20. The wall portion of the tank body portion 33 is attached to the rear portion of the side wall portion 24 and the extension portion 26 at a peripheral edge portion of the opening 39 in a close contact state. A space surrounded by the tank body portion 33 and a portion of the trunk 20 that closes the opening 39 constitutes the storage chamber 32.

The tank body portion 33 includes an injection pipe portion 41 for injecting the washer fluid 31 into the storage chamber 32 from the outside. The injection pipe portion 41 protrudes upward from the upper wall portion 35 in a state in which the inside and the outside of the storage chamber 32 communicate with each other. The injection pipe portion 41 penetrates the flange portion 27 at the notch 28 in the upper-lower direction. At least a part of the injection pipe portion 41 including an upper end portion is exposed above the flange portion 27. A piping member (not shown) that guides the washer fluid 31 to the storage chamber 32 is connected to the exposed portion.

### Materials for Forming Trunk 20 and Tank Body Portion 33

The trunk 20 and the tank body portion 33 are each made of a resin material. Examples of the resin material include polypropylene (PP) and acrylonitrile-butadiene-styrene copolymer (ABS). In the present embodiment, the trunk 20 and the tank body portion 33 are made of the same type of resin material. The trunk 20 and the tank body portion 33 may be made of different types of resin materials on condition that the trunk 20 and the tank body portion 33 can be welded.

The trunk 20 is formed using a resin material colored in black or the like, for example, a colored resin material in which a coloring agent such as a pigment, for example, black, is mixed into the resin material. This is to prevent members located below the trunk 20 from being seen through the trunk 20 by restricting visible light from passing through the trunk 20.

### Attachment Structure of Tank Body Portion 33 to Trunk 20

The wall portion of the tank body portion 33 is joined to the trunk 20 at the peripheral edge portion of the opening 39 by welding in a close contact state. That is, an interface between the wall portion of the tank body portion 33 and the trunk 20 is melted by heat, and thus the wall portion is joined to the trunk 20. In the tank body portion 33, portions to be welded are inner edge portions of the lower wall portion 34, the upper wall portion 35, the front connecting wall portion 36, and the rear connecting wall portion 37. In the trunk 20, portions to be welded are a part of an outer side surface 24a of the side wall portion 24 on one side (left side) and a part of an outer side surface 26a of the extension portion 26. By the joining, the washer tank 30 is integrated with the trunk 20.

### Operations of Present Embodiment

As shown in FIG. 2, the trunk 20, which is disposed in the power source room 12 and has the accommodation portion 25, does not serve as a main structural member (framework member) of the vehicle 10, unlike the front end panel. The trunk 20 has a smaller effect on the ride comfort due to the rigidity of the vehicle body 11 than the main structural member of the vehicle 10. Therefore, even if the natural frequency of the entire trunk 20 and washer tank 30 is reduced due to the addition of the tank body portion 33 and the washer fluid 31, the ride comfort due to the rigidity is unlikely to be reduced due to the addition of the tank body portion 33 and the washer fluid 31.

Here, the total weight of the washer tank 30 is defined as the sum of the weight of the washer tank 30 and the weight of the washer fluid 31 in the storage chamber 32. As the washer fluid 31 is consumed, a fluid level 31a drops, for example, as shown by a two-dot chain line in FIG. 6. When the washer fluid 31 is replenished, the fluid level 31a rises, for example, as shown by a solid line in FIG. 6. As the fluid level 31a drops and rises, the total weight of the washer tank 30 fluctuates. However, this has little effect on the ride comfort due to the rigidity. The ride comfort due to the rigidity is unlikely to vary over time due to the fluctuation in the weight.

A portion of the trunk 20 that closes the opening 39 also serves as a part of the wall portion of the washer tank 30. In other words, a part of the trunk 20 and a part of the wall portion of the washer tank 30 are shared. Therefore, as compared with a case where the trunk 20 and the wall portion of the washer tank 30 do not have a common portion, the tank body portion 33 is disposed at a location closer to the trunk 20. The liquid storage structure in which the tank body portion 33 is attached to the trunk 20 occupies less space in the power source room 12 as compared with the case where the trunk 20 and the wall portion of the washer tank 30 do not have a common portion.

Further, the tank body portion 33 and the trunk 20 are sealed without any gaps at the portions joined by welding.

When the washer fluid 31 freezes in winter or the like, the washer fluid 31 expands and increases in volume. At this time, stress generated due to the expansion acts on the tank body portion 33 and the trunk 20. However, the tank body portion 33 and the trunk 20 are both made of a resin material. Therefore, the extension (deformation) of the tank body portion 33 and the trunk 20 absorbs a part of the stress.

### Effects of Present Embodiment

(1) As shown in FIG. 6, the tank body portion 33 constituting an outer frame portion of the washer tank 30 has an opening 39 in a part of the wall portion. In a state in which the opening 39 is closed by the rear portion of the side wall portion 24 and the extension portion 26 of the trunk 20, the wall portion of the tank body portion 33 is attached to the trunk 20 at the peripheral edge portion of the opening 39 in a close contact state. The washer tank 30 is constituted by the tank body portion 33 and the portion of the trunk 20 that closes the opening 39.

Therefore, it is possible to suppress a decrease in the ride comfort due to the rigidity of the vehicle body 11 caused by the addition of the tank body portion 33 and the washer fluid 31. Further, even if the total weight of the washer tank 30 fluctuates due to consumption and replenishment of the washer fluid 31, the effect due to the consumption and replenishment on the ride comfort due to the rigidity may be reduced. In either case, the tank body portion 33 is attached to the trunk 20 and the washer fluid 31 is stored in the storage chamber 32, but the effect on the steering stability of the vehicle 10 may be reduced.

The tank body portion 33 can be disposed at a location closer to the trunk 20. The liquid storage structure may reduce the space it occupies in the power source room 12 and improve the space efficiency of the power source room 12.

(2) In an electric vehicle, as shown in FIG. 2, the power source room 12 tends to be provided in front of the vehicle interior 15. In the electric vehicle, there is a need to dispose the trunk 20 (frunk) having a large-capacity accommodation portion 25 in the power source room 12.

On the other hand, in a case where the trunk 20 and the washer tank 30 are separately attached to the vehicle body 11, a gap is provided between the trunk 20 and the washer tank 30 to avoid mutual interference. The capacity of the accommodation portion 25 is reduced by the amount of this gap.

In this regard, in the present embodiment, since the washer tank 30 is configured by joining the tank body portion 33 to the trunk 20, no gap is required between the tank body portion 33 and the trunk 20. This unnecessary gap may be used to increase the capacity of the accommodation portion 25, thereby meeting the need for a large-capacity accommodation portion 25.

(3) As shown in FIG. 6, the trunk 20 and the tank body portion 33 are both made of a resin material. Therefore, even if the washer fluid 31 freezes and expands, and stress is generated due to the expansion and acts on the trunk 20 and the tank body portion 33, the stress may be reduced.

Since the front end panel described in Patent Literature 1 is made of a resin material having high strength, it is difficult to obtain such an effect.

(4) The wall portion of the tank body portion 33 is joined to the trunk 20 at the peripheral edge portion of the opening 39 by welding. Therefore, it is possible to appropriately restrict the washer fluid 31 stored in the storage chamber 32 from leaking from the joint portion between the tank body portion 33 and the trunk 20.

The number of components may be reduced compared with a case where the washer tank 30 is attached to the trunk 20 by a fastening member, a locking member, or the like after the trunk 20 and the washer tank 30 are formed separately. In addition, it is possible to reduce the number of attachment steps and improve the ease of attachment.

(5) The trunk 20 and the tank body portion 33 are made of the same type of resin material. Therefore, at the time of welding, the tank body portion 33 and the trunk 20 that are melted by heat may be suitably mixed at the interface portion and joined more firmly.

(6) As shown in FIGS. 1 and 4, the washer tank 30 is integrated with the trunk 20 to form a module. Therefore, by attaching the trunk 20 to the vehicle body 11, the washer tank 30 may also be attached to the vehicle body 11 together with the trunk 20. The ease of attachment may be improved as compared with a case where the trunk 20 and the washer tank 30 are separately attached to the vehicle body 11.

(7) The front end panel may be integrated with the tank body portion 33. On the other hand, the front end panel is a structural member of the vehicle 10, and is an extremely important member as a framework member. Therefore, it is desirable that the front end panel can be commonly used for different vehicle models rather than being developed for each vehicle model. However, if the front end panel is integrated with other members such as the tank body portion 33, it is difficult to commonly use the front end panel. In this regard, in the present embodiment, the tank body portion 33 is not integrated with the front end panel. Therefore, the front end panel may be easily used in common for different vehicle models.

On the other hand, the shape of the trunk 20 generally tends to be different depending on the vehicle model. Therefore, there is little advantage in commonly using the trunk 20 for different vehicle models. In this regard, in the present embodiment, the tank body portion 33 is integrated with the trunk 20. There are no or few disadvantages caused by integrating the tank body portion 33 with the trunk 20.

(8) The trunk 20 has more regions where the tank body portion 33 can be joined than the front end panel. Therefore, there are many options for the location where the tank body portion 33 is to be disposed. Therefore, there is a high degree of freedom in design related to the location where the tank body portion 33 is disposed.

### Modifications

The present embodiment can be modified and implemented as follows. The present embodiment and the following modifications can be combined with each other and implemented without technical contradiction.

### Configuration of Trunk 20

The flange portion 27 may be formed at a location lower than an upper end portion of the accommodation portion 25.

The shape of the trunk 20 may be changed to a shape different from that of the above embodiment in accordance with the arrangement of surrounding components.

The accommodation portion 25 may be open at a location different from an upper end portion of the trunk 20, for example, at a rear end portion or a side end portion.

### Materials for Forming Trunk 20 and Tank Body Portion 33

The trunk 20 and the tank body portion 33 may be formed using a composite material in which a resin material is used as a base material and the base material is reinforced with a reinforcing material. Examples of the composite material include those obtained by reinforcing PP as a base material with talc, glass fiber, EPDM, or the like as a reinforcing material. In this case, since the base material is a resin material, it is possible to obtain the same effect as in (3) described above by deforming the trunk 20 and the tank body portion 33 when the washer fluid 31 freezes, depending on a blending amount of the reinforcing material.

One of the trunk 20 and the tank body portion 33 may be made of a composite material, and the other may be made of a resin material not blended with a reinforcing material. The base material in the former composite material and the latter material may be the same type of resin material or different types of resin materials. In this case, one of the trunk 20 and the tank body portion 33 made of the latter material can be deformed when the washer fluid 31 freezes. One of the trunk 20 and the tank body portion 33 made of the former material can be deformed when the washer fluid 31 freezes, depending on the blending amount of the reinforcing material.

Therefore, in this modification, it is also possible to obtain the same effect as in (3) described above.

In addition, the trunk 20 and the tank body portion 33 may be made of a composite material in which a reinforcing material is mixed with a resin material as a base material at different mixing ratios. The base materials in the composite material may be the same type of resin material or different types of resin materials. In this case, since the base materials are resin materials, it is possible to obtain the same effect as in (3) described above by deforming the trunk 20 and the tank body portion 33 when the washer fluid 31 freezes, depending on a blending amount of the reinforcing material.

### Liquid Tank

The liquid tank may be changed to a tank that stores a liquid different from the washer fluid 31, for example, a reservoir tank that stores a coolant.

The shape of the tank body portion 33 may be changed to a shape different from that of the above embodiment in accordance with the arrangement of surrounding components.

The tank body portion 33 having an opening 39 in a part of a wall portion may be disposed in the accommodation portion 25. In a state in which the opening 39 is closed by a part of the trunk 20, the wall portion of the tank body portion 33 may be attached to the trunk 20 at a peripheral edge portion of the opening 39 in a close contact state. The liquid tank may be constituted by the tank body portion 33 and the portion of the trunk 20 that closes the opening 39. The tank body portion 33 may be made of a transparent resin material.

According to this modification, the liquid stored in the liquid tank can be seen through the tank body portion 33. Therefore, it is easy to check the amount (content) of the liquid stored in the storage chamber 32.

As in the above embodiment, in a case where the tank body portion 33 is disposed only on one side of the accommodation portion 25 in the left-right direction, at least one of the notch 28 in the flange portion 27 and the extension portion 26 may be omitted on the side where the tank body portion 33 is not disposed.

The same tank body portion 33 may be disposed at a location on a side (right side) opposite to the tank body portion 33 of the above embodiment with the accommodation portion 25 interposed therebetween in the left-right direction, and may be attached to the trunk 20.

In other words, the tank body portions 33 may be disposed on both sides of the accommodation portion 25 in the left-right direction. In this case, the added tank body portion 33 is disposed below the flange portion 27. The injection pipe portion 41 protruding upward from the upper wall portion 35 of the tank body portion 33 penetrates the flange portion 27 at the notch 28 in the upper-lower direction. The same type of liquid is stored in both the storage chambers 32.

According to this modification, the total capacity of a liquid that can be stored in the vehicle 10 can be increased as compared with a case where the tank body portion 33 is disposed on one side.

A liquid tank for storing a liquid of a type different from that of the washer fluid 31 may be provided at a location on a side (right side) opposite to the tank body portion 33 of the above embodiment with the accommodation portion 25 interposed therebetween in the left-right direction.

The tank body portion 33 may have an opening 39 in an upper portion instead of an inner portion of a wall portion.

In this case, the tank body portion 33 is disposed, for example, below the flange portion 27. The injection pipe portion 41 is provided at a location on the wall portion of the tank body portion 33 that is different from the upper wall portion 35. In a state in which the opening 39 is closed by a part of the flange portion 27, the wall portion of the tank body portion 33 may be joined to the flange portion 27 at a peripheral edge portion of the opening 39 in a close contact state.

The tank body portion 33 and the portion of the flange portion 27 that closes the opening 39 constitute a liquid tank.

The tank body portion 33 may have an opening 39 in the upper portion instead of the inner portion of the wall portion. In this case, the tank body portion 33 is disposed, for example, below the flange portion 27. The injection pipe portion 41 is provided at a location on the wall portion of the tank body portion 33 that is different from the upper wall portion 35. In a state in which a portion of the opening 39 located at an inner portion of a wall portion is closed by the side wall portion 24 and the extension portion 26, the wall portion of the tank body portion 33 is joined to the side wall portion 24 and the extension portion 26 at a peripheral edge portion of the opening 39 in a close contact state. In addition, a portion of the opening 39 located at an upper portion of the wall portion may be joined to the flange portion 27 in a close contact state. The tank body portion 33 and a portion of the trunk 20 that closes the opening 39 constitute a liquid tank.

### Attachment Structure of Tank Body Portion 33

The tank body portion 33 may be attached to the trunk 20 by a joining method different from welding, for example, by adhesion.

### Others

The liquid storage structure can also be applied to a vehicle 10 in which the power source room 12 is provided at the rear of the vehicle interior 15 and the trunk 20 and the liquid tank are disposed in the power source room 12.

In the above embodiment, the trunk 20 including the flange portion 27 is made of a resin material colored in black or the like, and does not transmit or hardly transmits visible light. Therefore, in the power source room 12, a component disposed around the trunk 20 may be disposed below the flange portion 27. Further, the component may be attached to the trunk 20 below the flange portion 27. Examples of the corresponding component include a wire harness. When the injection pipe portion 41 is disposed below the flange portion 27, the piping member connected to the injection pipe portion 41 is the corresponding component.

According to the above modification, when the power source room 12 of the vehicle 10 is viewed from above with the bonnet hood 13 open, the above component is hidden by the trunk 20. Therefore, the appearance around the trunk 20 in the power source room 12 is improved.

A seal member such as a weather strip may be attached to a portion of the flange portion 27 that includes at least a portion between the injection pipe portion 41 and the accommodation portion 25. The seal member may be attached to the flange portion 27 while surrounding the injection pipe portion 41.

In this case, when the washer fluid 31 is poured from the injection pipe portion 41 into the washer tank 30 for replenishment of the washer fluid 31, even if the washer fluid 31 spills out of the injection pipe portion 41, the washer fluid 31 can be blocked by the seal member.

The seal member can restrict a spilled liquid from flowing into the accommodation portion 25 along the flange portion 27.

In general, in a vehicle on which a pop-up hood is mounted, when an impact is applied due to a collision or the like, a rod protrudes upward from an actuator to push up a front end portion of a bonnet hood. The above liquid storage structure may be applied to a vehicle of such a type. In this case, for example, a rod passage hole is formed in the flange portion 27. The actuator may be disposed below the flange portion 27 in the trunk 20.

According to this modification, when an impact is applied to the vehicle 10, the rod rises through the hole of the flange portion 27 and pushes up a front end portion of the bonnet hood 13. When the actuator is not in operation, the actuator is hidden by the trunk 20 when the power source room 12 of the vehicle 10 is viewed from above with the bonnet hood 13 open. Therefore, the appearance around the trunk 20 in the power source room 12 is improved.

The vehicle interior outer chamber may be configured by a room different from the power source room 12, or in other words, a room in which a power source such as an engine or a motor is not accommodated, on condition that the room is provided outside the vehicle interior 15 of the vehicle 10.

What is claimed is:

1. A liquid storage structure for a vehicle, the liquid storage structure being applied to a vehicle in which a vehicle interior outer chamber is provided outside a vehicle interior, and a trunk and a liquid tank having a liquid storage chamber are disposed in the vehicle interior outer chamber, wherein
a framework portion of the liquid tank is configured by a tank body portion, the tank body portion having a wall portion forming an outer shell portion,
the tank body portion has an opening in a part of the wall portion,
in a state in which the opening is closed by a part of the trunk, the wall portion of the tank body portion is attached to the trunk at a peripheral edge portion of the opening in a close contact state, and
the liquid tank is constituted by the tank body portion and the part of the trunk that closes the opening.

2. The liquid storage structure for a vehicle according to claim 1, wherein
a liquid stored in the storage chamber is a washer fluid, and
the trunk and the tank body portion are each made of a resin material.

3. The liquid storage structure for a vehicle according to claim 1, wherein
the trunk and the tank body portion are made of a resin material or a composite material obtained by reinforcing a resin material with a reinforcing material, and
the wall portion of the tank body portion is joined to the trunk at the peripheral edge portion of the opening by welding.
